(19) United States
(12) Patent Application Publication
(10) Pub. No.: US 2008/0050689 A1
(43) Pub. Date: Feb. 28, 2008

(54) Method of stabilising a refractory inner wall of a hot blast generating device and use thereof in a hot repair method

(75) Inventors: August Hugo Hendriks, Zaandijk (NL); Frank Thomas Niemeijer, Nieuwe Niedorp (NL)

Correspondence Address: STEVENS DAVIS MILLER & MOSHER, LLP, 1615 L STREET, NW, SUITE 850, WASHINGTON, DC, 20036, US

(73) Assignee: Danieli Corus Technical Services BV, Ijmuiden (NL)

(21) Appl. No.: 11/889,577

(22) Filed: Aug. 14, 2007

(30) Foreign Application Priority Data
Aug. 15, 2006 (EP) 06016983.6

(51) Int. Cl. F27D 1/14; F27D 1/16

(52) U.S. Cl. 432/76; 248/351

(57) ABSTRACT

The invention relates to a method of stabilising a refractory inner wall of a hot blast generative device having a wall configuration comprising an outer wall and a refractory inner wall, in particular the refractory inner wall of the combustion chamber of a hot blast generative device According to the invention the method comprises the steps of providing one or more holes through said wall configuration from the outside of the hot blast generative device; introducing a support for supporting the refractory inner wall in a hole thus provided, fixing said support to the outer wall.

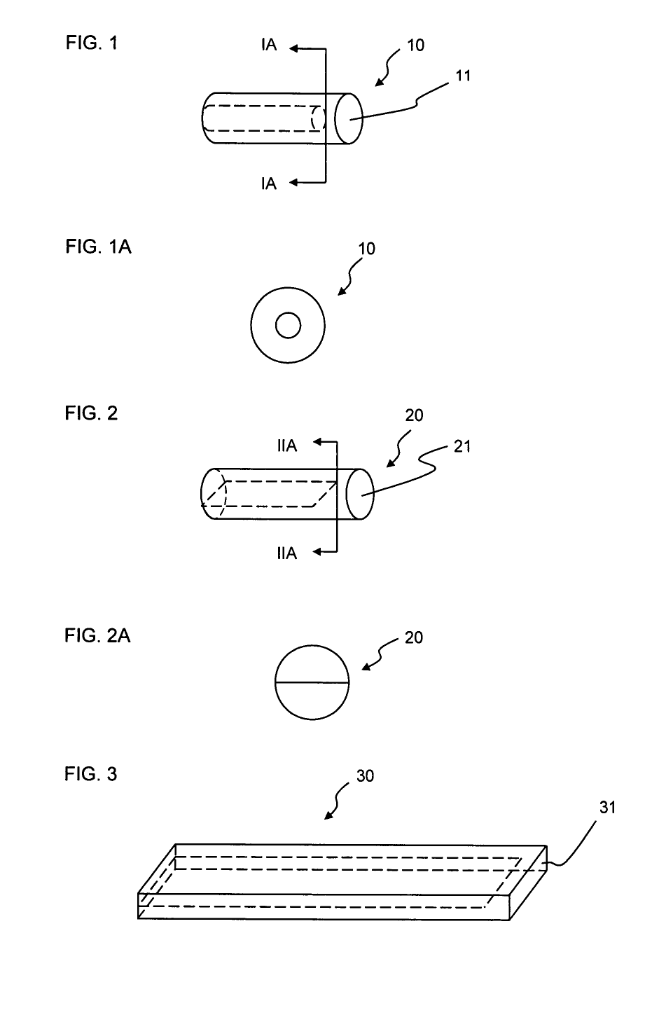

The present invention relates to a method of stabilising a refractory inner wall of a hot blast generative device, such as a regenerative hot blast stove for a blast furnace, and to the use thereof in a hot repair method.

A hot blast stove is device used for providing hot air to a blast furnace. Such a hot blast stove is a large hot blast generating device, which can also be used in general industrial furnaces. Typically such a hot blast stove comprises a combustion chamber or shaft and a regenerative shaft being in fluid connection at the top of the stove or inside the stove. The combustion chamber comprises a burner for production of hot combustion exhaust gas. The regenerative shaft is usually filled with a checker work. In a certain type of hot blast stoves (external burner) the combustion shaft and the regenerative shaft each comprise a refractory lining within a (steel) shell. In another type (internal burner) both shafts are arranged within one and the same outer shell having an internally refractory lining and partition. During operation air is heated in a two stage process in the hot blast stove. The first stage is the so-called “on gas” phase, in which the checker work in the regenerative shaft is heated by the hot combustion gases from the burner in the combustion shaft. The second stage is the so-called “on blast” phase, wherein the checker work thus heated transfers its heat to air passing through, e.g. air is heated from about 100° C. to a temperature of about 1300° C., which air is used in the blast furnace. This regenerative heating process is a discontinuous process. In order to achieve a continuous flow of hot air to the blast furnace at least two hot blast stoves are required. Typically a plurality of hot blast stoves are grouped together in the vicinity of a blast furnace.

During operation of a hot blast stove damages to the burner construction in the lower end of the combustion shaft and to the refractory lining, in particular in a zone exposed to the flames of the burner and at a region near the hot blast outlet may occur. Known causes are the leakage of cooling water, e.g. from the water cooled hot blast outlet into the combustion shaft, causing serious breakdown of the refractory lining, and the continuous thermal cycle to which the burner construction and refractory lining is subjected. The result thereof is a decrease of the performance of the hot blast stove.

Traditionally repair of the damaged hot blast stove requires to stop operation thereof completely. After cooling down—which usually takes 10-20 days—maintenance and repair can be carried out. Afterwards the hot blast stove needs to start up again. This is time-consuming, inefficient and expensive.

In order to remedy these drawbacks so-called hot repair methods are designed. See e.g. “Hot repair of ceramic burner on hot blast stoves at USS/KOBE's #3 blast furnace” by T. F. Bernarding et al. in 1997 Ironmaking Conference Proceedings, page 263-267. This known hot repair method consists of pulling the hot blast valve out and bulkheading the hot blast main during a short duration outage (about 20 hrs.). The stove is also isolated from the cold blast and the chimney (waste gas) connections. Then a heat shield is inserted into the combustion shaft above the burner through the hot blast outlet and unfolded in order to protect the damaged area from the hot upper walls and dome of the combustion shaft. Optionally, a temporary burner can be used to maintain the temperature of silica refractories and dome at an elevated temperature. The heat shield used is a four piece unfolding heat shield, mounted onto an acme screw jacking mechanism that is mounted on rails. This whole assembly is introduced via the hot blast outlet from which the valve is removed. Such a hot repair method requires substantially less time, and is therefore advantageous from economic point of view.

However, such a hot repair method brings about serious risks for the people carrying out the maintenance and/or repair work. One of these risks is that the heat shield does not have sufficient mechanical strength in case refractory lining from the upper part of the combustion chamber is released. Furthermore repairing damage to the construction often requires the removal of refractory material, thereby increasing the risk of a (partial) collapse of the refractory lining from a position above the damaged parts being repaired. The total mass of the refractory lining (e.g. having a thickness of 0.5-1 m) above a damaged location in the lower region of the combustion shaft may range from 1 to 10 times 10⁵ kg. Also the introduction of the unfolding heat shield together with the jacket means and rails into the combustion shaft is dangerous and complicated.

It is an object of the present invention to provide an improved method of stabilising the refractory inner wall of a hot blast generative device.

It is another object of the present invention to provide an improved method of stabilising the refractory lining of a hot blast generative device while the device is still hot.

It is yet another object of the present invention to provide a method of stabilising the refractory inner wall of a hot blast generative device that is easy and fast in use.

It is also an object of the present invention to provide an improved method of repairing a hot blast generative device, which does not show one or more of the abovementioned disadvantages, or at least a suitable alternative method.

It is moreover an object of the present invention to provide a method of repairing a hot blast generative device while it is (still) hot, which is more safe than the known hot repair methods.

It is still another object of the invention to provide a method of repairing a hot blast generative device which does not require the actual entry of people in the stove.

Yet another object of the invention is to provide such a method, which can be carried out at a considerable rate thereby resulting in a cost-effective method.

The present invention provides a method of stabilising a refractory inner wall of a hot blast generative device having a wall configuration comprising an outer wall and a refractory inner wall, in particular the refractory inner wall of the combustion chamber of a hot blast generative device, comprising the steps of
providing one or more holes through said wall configuration from the outside of the hot blast stove;
introducing a support for supporting the refractory inner wall in a hole thus provided,
fixing said support to the outer wall.

The present invention is based on the insight that stabilisation of the inner refractory wall generally increases the safety of the hot blast stove whether actual entry is required or not. According to the invention this stabilisation can be achieved in a few steps, which can be carried out with relatively simple means in a short period of time. In a first step one or more holes are provided from the outside of the hot blast generative device through the wall structure thereof, e.g. drilling of a hole having a diameter of about 30-40 centimeters can be done in about 30-60 minutes. Then a support is inserted in the hole. Once in position, this support has a supporting end contacting and carrying the refractory part above, a middle portion extending through the outer wall and a fixing end that remains outside the hot blast stove. Then the support is secured to the outer wall making use of the fixing end thereof, e.g. by welding or any other suitable securing technique. Advantageously a support is fixed to the outer wall at a position above the respective hole. The support carrying the refractory lining and fixed to the outer shell acts like a mechanical anchor and thereby stabilises the hot blast stove. The stabilising method according to the invention allows for several modes of repair as will be explained hereinafter.

In order to take full advantage of the possibilities that the present invention offers preferably the support is cooled while the hot blast stove is (still) hot. No cooling off and heating up time is thus needed. The support is thus exposed to very high temperatures. Most materials suitable for manufacturing and functioning as a support like metals are not able to withstand these high temperatures. Therefore it is necessary to cool the support. Suitable cooling fluids are water, air and a mixture thereof, or alternative cooling media.

In a preferred embodiment the support comprises a tubular section provided with an end wall at one end, the tubular section comprising a flow channel for a cooling fluid. Such a support is inserted into a hole with its end wall first. The inlet and outlet of the flow channel are connected to a source of cooling fluid and a discharge thereof respectively. Thus, a simple cooling of the support can be provided.

Preferably a support comprises a tubular outer section having an end wall at one end, a tubular inner section being arranged in said tubular outer section spaced apart from the inner periphery of the outer section and at a predetermined distance from the end wall, thereby defining an inner flow channel and an outer flow channel surrounding the inner flow channel for circulation of a cooling fluid, the inner flow channel and the outer flow channel being in fluid communication with each other at said end wall. Thus a very effective cooling is provided.

Alternatively a support comprises a tubular section having an end wall at one end, and a partition extending in the longitudinal direction of the tubular section and spaced apart at a predetermined distance from the end wall, thereby defining a first flow channel and a second flow channel for circulation of a cooling fluid, the first and second flow channels being in fluid communication with each other at said end wall. This supports also provides an effective cooling, but here the flow channel where the cooling fluid enters cools better than the outlet.

Preferably in this last method said support comprises an I profiled section having side walls running parallel to the main beam of said I profiled section. This support is easy to make.

According to a preferred embodiment the support has a length larger than the thickness of the wall construction of the hot blast generative device and a fixing means is provided at the outer end of the support remaining outside said hole. In this way, the fixing means can have a good connection to the outer end of the support and said fixing means can be fixed to the outer wall of the hot blast generative device.

Preferably, the fixing means comprises a fixing arm extending upwardly. In this way the force exerted by the mass of the refractory inner wall is directly led to the outer wall.

According to a preferred embodiment the support furthermore comprises a top support plate having a shape corresponding to the respective part of the hole. In this way the force exerted by the mass of the refractory wall is spread over the supporting plate and thus the support will be more evenly loaded.

According to a preferred embodiment a plurality of holes is provided at positions distributed over the periphery of the combustion chamber of the hot blast generative device. This is especially advantageous when an external burner is used, so the holed can be provided along the full periphery of the combustion shaft.

According to another preferred embodiment a series of overlapping adjacent holes is provided. In this way an elongated opening is provided in the wall configuration, through which a device can be introduced in the combustion chamber, for instance having a larger dimension than the diameter of a hot blast outlet.

Advantageously the cross-section of a support is smaller than the cross-section of a hole, and the support is introduced in the upper part of said hole leaving clear a gap at a lower part of said hole. The gap can thus be used to introduce a device into the inside of the hot blast generative device.

According to a preferred embodiment a step of inserting a heat shield through the gap beneath said supports, and a step of mounting the heat shield in the combustion chamber is added. The heat shield can comprise two or more parts that are placed side by side to fill the whole section of the inside of the blast generative device or combustion chamber. Instead of or in addition to a heat shield a safety deck can be inserted through the gap.

Preferably said mounting comprises a step of providing supporting pens for supporting the heat shield, the pens preferably extending over the cross section of the combustion chamber. Using such pens a light weight and soft heat shield can be used.

Advantageous the method further comprises the step of repairing a damaged inner wall part, preferably by introduction of a nozzle in the combustion chamber and spraying a flowable repair agent onto the damaged inner wall part. In this way the inner wall part can be repaired without anyone having to enter the hot blast generative device.

Preferably the hot blast generative device is a regenerative hot blast stove. The invention also provides the use of a stabilising method according to the above method in a hot repair method of a damaged hot blast generative device, in particular the refractory inner wall of the combustion chamber or the burner thereof. It will be clear to the person skilled in the art that the stabilising method according to the invention can be used during many if not all hot repair methods for repairing a hot blast generative device.

1. A method of stabilising a refractory inner wall of a hot blast generative device having a wall configuration comprising an outer wall and a refractory inner wall, comprising the steps of:
providing one or more holes through the wall configuration from the outside of the hot blast generative device;
introducing a support for supporting the refractory inner wall in a hole thus provided,
fixing the support to the outer wall.

2. The method according to claim 1, wherein the support is cooled when the combustion chamber is hot.

3. The method according to claim 1, wherein the support comprises a tubular section provided with an end wall at one end, the tubular section comprising a flow channel for a cooling fluid.

4. The method according to claim 3, wherein the support comprises a tubular outer section having an end wall at one end, a tubular inner section being arranged in said tubular outer section spaced apart from the inner periphery of the outer section and at a predetermined distance from the end wall, thereby defining an inner flow channel and an outer flow channel surrounding the inner flow channel for circulation of a cooling fluid, the inner flow channel and the outer flow channel being in fluid communication with each other at the end wall.

5. The method according to claim 3, wherein the support comprises a tubular section having an end wall at one end, and a partition extending in the longitudinal direction of the tubular section and spaced apart at a predetermined distance from the end wall, thereby defining a first flow channel and a second flow channel for circulation of a cooling fluid, the first and second flow channels being in fluid communication with each other at the end wall.

6. The method according to claim 5, wherein the support comprises an I profiled section having side walls running parallel to the main beam of the I profiled section.

7. The method according to claim 1, wherein the support has a length larger than the thickness of the wall construction of the hot blast generative device and a fixing means is provided at the outer end of the support remaining outside the hole.

8. The method according to claim 7, wherein the fixing means comprises a fixing arm extending upwardly.

9. The method according to claim 7, wherein the support further comprises a top support plate having a shape corresponding to the respective part of the hole.

10. The method according to claim 1, wherein a plurality of holes is provided at positions distributed over the periphery of the combustion chamber of the hot blast generative device.

11. The method according to claim 1, wherein a series of overlapping adjacent holes is provided.

12. The method according to claim 11, wherein the cross-section of the support is smaller than the cross-section of the respective hole, and the support is introduced in the upper part of the hole leaving clear a gap at a lower part of the hole.

13. The method according to claim 12, further comprising a step of inserting a heat shield through the gap beneath the supports, and a step of mounting the heat shield in the combustion chamber.

14. The method according to claim 13, wherein the mounting comprises a step of providing supporting pens for supporting the heat shield.

15. The method according to claim 14, wherein the pens extend over the cross section of the combustion chamber.

16. The method according to claim 1, further comprising the step of repairing a damaged inner wall part by introduction of a nozzle in the combustion chamber and spraying a flowable repair agent onto the damaged inner wall part.

17. The method according to claim 1, wherein the hot blast generative device is a regenerative hot blast stove.

18. The method according to claim 1, wherein the refractory inner wall of the hot blast generative device is a refractory inner wall of a combustion chamber of the hot blast generative device.

19. The method according to claim 1, wherein the method is performed for a hot repair of a damaged said hot blast generative device.

20. The method according to claim 18, wherein the method is performed for a hot repair of a damaged refractory inner wall of the combustion chamber of said hot blast generative device or the burner of said combustion chamber of said hot blast generative device.
